(19) United States
(12) Patent Application Publication
(10) Pub. No.: US 2005/0120039 A1
(43) Pub. Date: Jun. 2, 2005

(54) System, method and software for acquiring, storing and retrieving electronic transactions

(75) Inventors: Jennifer Amys, Bloomington, MN (US); Chung Crowley, Redondo Beach, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Upstream Software, Inc.

(21) Appl. No.: 10/666,728

(22) Filed: Sep. 19, 2003

Related U.S. Application Data
(60) Provisional application No. 60/412,192, filed on Sep. 19, 2002.

(51) Int. Cl. G06F 17/00

(52) U.S. Cl. 707/102

(57) ABSTRACT

A method, system, apparatus and data structure is described wherein two or more different systems producing electronic data relating to a transaction involving documentation communicated in an electronic form. Copies of the electronic data are processed to identify electronic documentation items and at least one key value associated with an electronic documentation item. A key value is used to look up a transaction identifier associated with the transaction, and documentation items are indexed according to the key value and transaction identifier. Documentation items are archived in a data storage system or device, and a date and/or time is logged for at least some of the documentation items.

This application claims priority to U.S. Provisional Application No. 60/412,192 filed Sep. 19, 2002, which is incorporated herein by reference.

### TECHNICAL FIELD OF THE INVENTION

The present invention pertains generally to data processing, and more particularly to electronic transactions carried out between one or more entities.

### BACKGROUND OF THE INVENTION

As companies push forward with their e-business initiatives, e-commerce becomes the way they transact their business. On the supply side, there are industry-specific trading exchanges for their sourcing needs, point-to-point supplier integration and collaboration for strategic sourcing partners, and e-procurement system for online purchasing of indirect materials. On the demand side, there are channel partner integration, electronic transaction exchange with customers, and the online web storefront for both business to business (B2B) and business to consumer (B2C) transactions.

With these possible e-commerce activities from all corners of an industry, the management of these electronic transactions is understandably becoming complex. How does a company keep track of all these activities and organize these outside data in such a way that it commingles with internal data? How does a company turn this voluminous data into business intelligence?

One technology that comes to mind is the search engine. Both businesses and consumers are increasingly dependent on the search engine to fetch the information they need from the Internet and private corporate portals. Significant research and development is currently underway to make search engines return more relevant information and boost the efficiency of its search algorithm. However, while the search engine technology works well for general document retrieval, it is not adequate for e-commerce related document management, because it lacks the ability to thread together the related documents for a given business transaction.

### BRIEF DESCRIPTION OF THE DRAWINGS

FIG. 1 illustrates an overview of the deployment of an example embodiment of the invention in a corporate computing environment.

FIG. 2 illustrates a variety of electronic documents typically used in electronic transactions in business transactions.

FIG. 3 illustrates an example embodiment of a system, method, data structure and computer program according to the present invention.

FIG. 4 illustrates an example application of the embodiment of FIG. 3.

FIGS. 5 and 6 illustrate an example embodiment of a retrieval mechanism according to the present invention.

FIG. 7 illustrates a retrieval processor with a display module according to the present invention.

FIG. 8 illustrates a query input screen according to an example embodiment according to the present invention.

### DETAILED DESCRIPTION OF THE INVENTION

In the following detailed description of the embodiments, reference is made to the accompanying drawings, which are shown by way of illustration of specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present inventions. It is also to be understood that the various embodiments of the invention, although different, are not necessarily mutually exclusive. For example, a particular feature, structure or characteristic described in one embodiment may be included within other embodiments. The following description is, therefore, not to be taken in a limiting sense.

According to one example embodiment of the invention, there is provided an electronic transaction capture, storage and retrieval system that leverages the available, voluminous electronic documents generated by e-commerce activities. By analyzing these electronic documents and identifying their relationships, the system is able to present users a complete picture of each and every electronic transaction from the origination to the conclusion as it passes through various enterprises participating in the business transaction.

According to one example embodiment of a method and system according to the invention, a user enters a PO number as the search keyword, and the system returns all documents associated with this transaction, from the original purchase order to the shipping documents to the invoice, and subsequently to the final payment voucher, even though the original purchase order number may not appear in all documents. With the ability to string these related documents together, the user can easily analyze and reconcile the transaction, and solve any discrepancies.

According to another example embodiment of the invention, there is provided an electronic transaction capture, repository and management system. According to one example implementation, the system does not replace a company's existing e-commerce system, such as electronic data interchange (EDI) software or XML integrator. Rather, it works side by side with these systems.

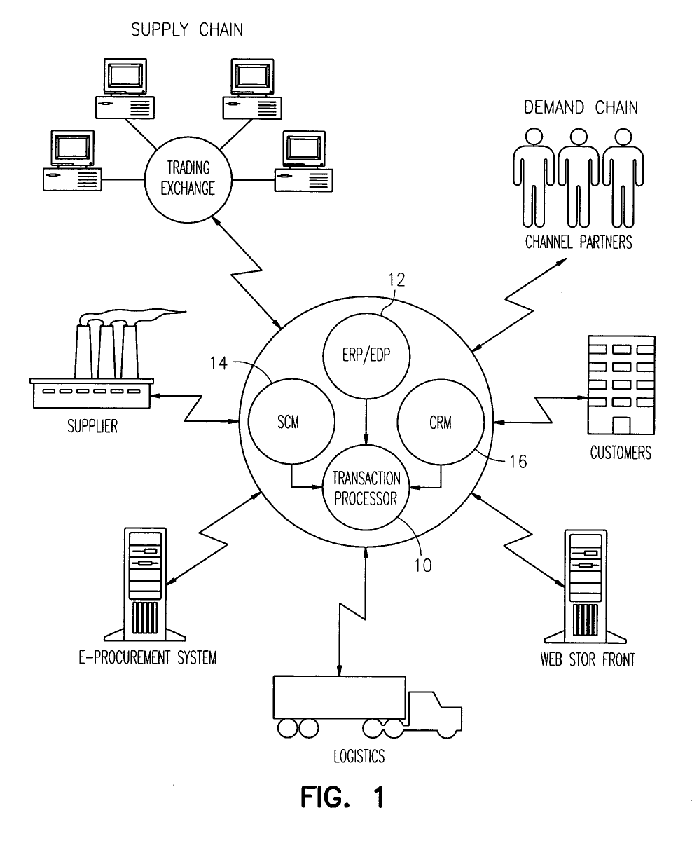

According to this example embodiment of the system and method of the invention illustrated in FIG. 1, the system 10 requests a “carbon copy” of all electronic documents passing through a company's various e-commerce systems such as an ERP system or EDI software 12, supply chain management software 14, customer relationship management software 16, or other systems processing or producing electronic documents in electronic transactions. As described further below, the system 10 uses a translator and a standards database to index, correlate, and archive electronic documents based on their relationship in a business or other form of electronic transaction. The purpose of this process is to allow the complete visibility of a business transaction from initiation to conclusion to be accessible via a single request.

As is illustrated in FIG. 1, a copy of an electronic transaction is forwarded to the transaction processor from one or more different systems used by an entity for e-commerce, including transactions between different systems within the entity or between systems maintained by different entities, as may for example occur between different companies or legal entities or between divisions or subsidiaries or departments or groups of the same entity.

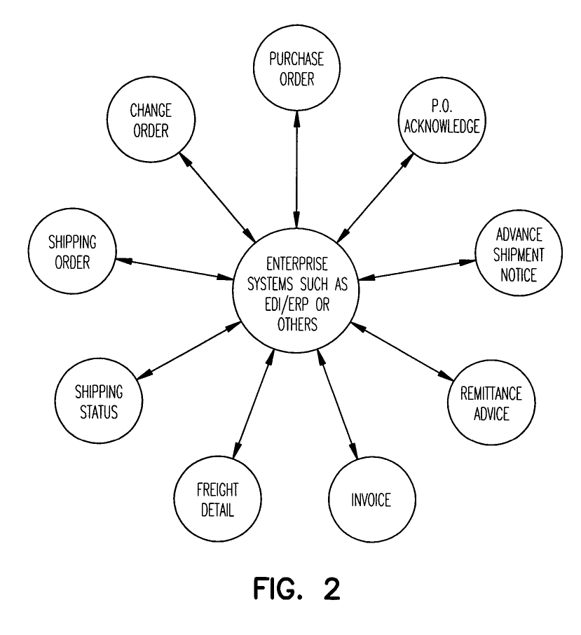

According to one example embodiment, the system is used in conjunction with a procurement process. As illustrated in FIG. 2, the life cycle of a procurement transaction starts with the initiation of a purchase order. From there, different companies are involved at various stages of the transaction, and many electronic documents are exchanged as the order moves through the supply chain. The potential electronic documents generated from this transaction often include: purchase order, change order, PO Acknowledgment, ship order, advance shipment notice, shipping status, freight detail, invoice, and remittance advice. Using one example embodiment of the system and method and software of the invention, as described further below, these documents are captured, indexed, archived, and made available to all parties involved in this transaction. For example, the buyer may search a “life cycle database” maintained by the system for the purchase order, and based on the latest document logged, he or she can easily find out the status of the order, answering such questions as: is it fulfilled or has it left the factory? The logistics company may search the life cycle database and match its load tender against the original purchase order if it is unclear about certain aspect of the shipment.

A system according to an example embodiment of the invention is also useful for reconciliation. For example, often times an account payable department has trouble reconciling some invoices with orders, and much manual effort is involved in researching the discrepancies. Traditionally, the search will include going through various internal systems such as the purchasing system, account payable system, pulling canceled checks from banks, playing telephone tags with vendors, faxing various pieces of document/printouts, for example. Using a system according to the present invention, all such related documents can be discovered with a single search. Either by the PO number or the invoice number, the system will make available both the invoice it received and the original order it sent on the same screen. It can spell out the date, ordered items, quantities, cost as well as receiving documents. As a result, there is the opportunity for substantial timesavings in the reconciliation effort.

Such a system according to the present invention is useful for capturing and maintaining an audit trail. In this example, the system receives a carbon copy of all the electronic documents exchanged by the company regardless of the type of e-commerce activities or the enterprise systems involved in the activities. In essence, the system acts as the central repository for the company's e-commerce activities, and provides a complete audit trail for it.

Furthermore, an embodiment of the present invention is also useful for applications other than e-commerce, such as general document management and retrieval management. In general, a capture, indexing and retrieval system according to the present invention is useful for any process that involves exchange of electronic documents or records between systems or parties to an electronic transaction.

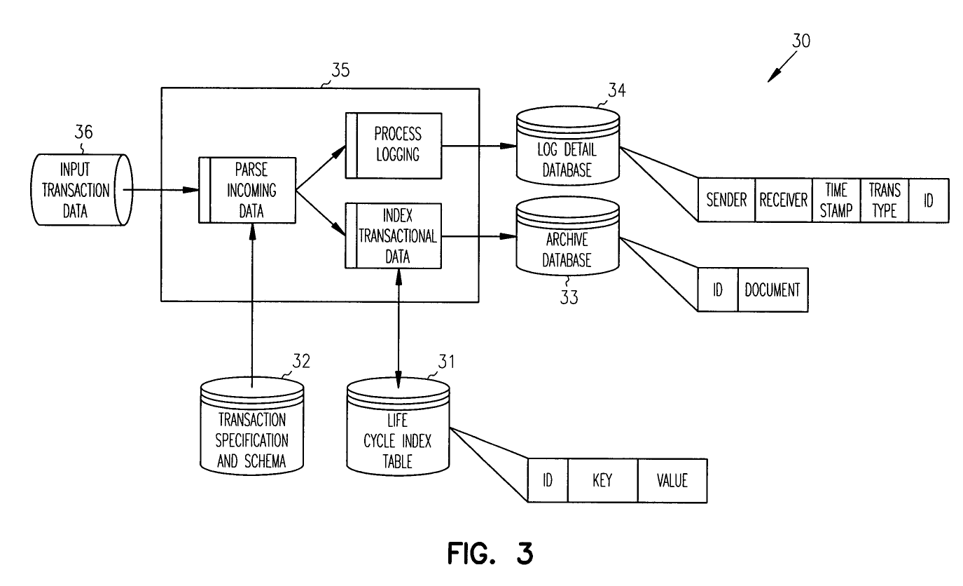

Referring now to FIG. 3, there is illustrated an example embodiment of a system, method and database structure and system 30 according to the present invention. The life cycle database structure includes the following:
A transaction specification database 32 that contains specifications and schema as well as the key identifiers or values of each transaction type. Key values include, for instance, P.O. numbers, invoice numbers, shipping document numbers.
A life cycle Index table 31 that contains the key values of the processed transactions (e.g., P.O. or invoice documents) and the assigned life cycle IDs for the key values.
An archive database 33 that contains the name and path of the archived documents or items and archive indexes.
A log detail database 34 that provides chronological order to transactions by logging and time stamping each transaction parsed. The name of the sender, receiver, time stamp, date stamp, transaction type, life cycle ID, and archive index are maintained.

Although the database structure has been illustrated in this example form, many other structures are possible for holding the data or portions of the data identified above and as used in at least some example embodiments of the invention. Accordingly, although the illustrated structure is one example form according to the present invention, it shall be understood that other example forms are also possible and anticipated for use in the transaction capture, storage and retrieval system, method and software according to the present invention.

As further illustrated in FIG. 3, transaction processor 35, which takes the form of software stored on a storage medium (such as magnetic or optical media, or conveyed as a data stream over a network) and executing on a data processing system, provides for, among other things, assigning a life cycle ID to electronic documents or items. When an electronic transaction is received as transaction data 36, the transaction processor 35 uses the specification stored in the transaction specification database 32 to parse and retrieve the key values of the transaction. These key values are then used to search the life cycle index table 31 to see whether or not any of these values have already been indexed. If one or more matches are found, the assigned life cycle IDs for the matched rows in the table are retrieved and used to archive and log the current transaction. If no match is found, the system 35 assigns a unique life cycle ID for each of the key values and adds these keys into the Index table 31. These life cycle IDs are then used to archive and log the current transaction.

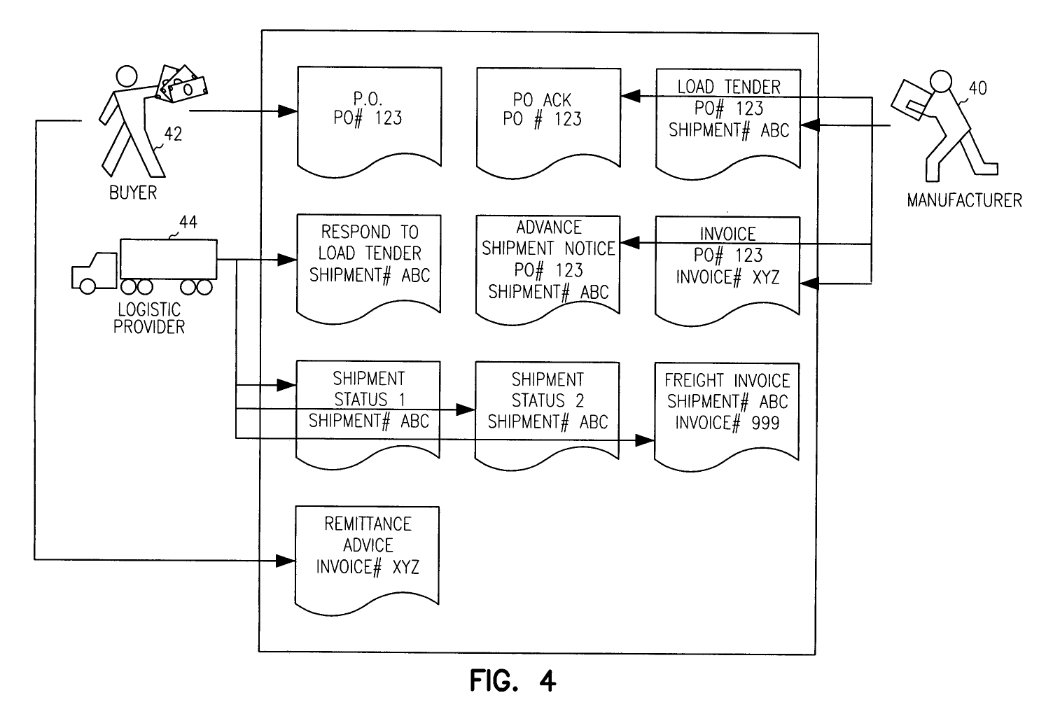

An example of such a transaction processing operation relating to an e-commerce sales transaction is illustrated in FIG. 4. In this example embodiment of operation, a consumer goods manufacturer 40 receives an electronic purchase order from one of its customers. A copy of this order is sent to Life Cycle for cataloging. This is Life Cycle transaction 1. Manufacturer 40 confirms to buyer 42 the acceptance of the order by sending out a PO acknowledgement transaction to buyer 42 (Life Cycle transaction 2). As the ship date approaches, manufacturer 40 issues a load tender transaction to its logistic service provider 44 to arrange the transportation needs (Life Cycle transaction 3). Logistic service provider 44 responds with an acceptance or rejection transaction for the load tender (Life Cycle transaction 4). Once the transportation is arranged, and the load is picked up at the manufacturer's loading dock, manufacturer 40 sends an Advance Shipment Notification to buyer 42 (Life Cycle transaction 5), followed by the invoice transaction (Life Cycle transaction 6) The transportation company sends shipment status at a pre-defined interval to advise manufacturer 40 of the status of the shipment (Life Cycle transaction 7-n). Once buyer 42 has received and verified the goods, it will notify its bank for electronic fund transfer, a remittance advice transaction is then sent, either by the bank or buyer 42, to manufacturer 40 advising the payment activity (Life Cycle transaction n+1). This concludes the life cycle of a business transaction in this example embodiment.

In this embodiment, the specification database will be preloaded with the specifications of the Life Cycle transactions described above: Purchase Order, Purchase Order Acknowledgement, Load Tender, Respond to Load Tender, Advance Shipment Notification, Invoice, Shipment Status, and Remittance Advice. These specifications are standard transaction descriptions agreed upon between the sending and receiving parties. It can be EDI standard transactions or industry specific XML transactions (in various embodiments), or even a proprietary transaction format (in another embodiment), as long as they have the agreement of both parties involved.

One embodiment of the invention provides a Life Cycle Index database. The Life Cycle Index database will be updated with the following entries (shown below in Table 1) as each transaction is processed through the Life Cycle Analyzer.

TABLE 1

| | Life Cycle | | |
|---|---|---|---|
| Document | ID | Index Key | Data value |
| PO | 1 | PO Number | 123 |
| PO Ack. | 1 | PO Number | 123 |
| Load Tender | 1 | PO Number | 123 |
| Load Tender | 2 | Shipment ID | abc |
| Respond to Load Tender | 2 | Shipment ID | abc |
| Advance Shipment Notice | 1 | PO Number | abc |
| Advance Shipment Notice | 2 | Shipment ID | abc |
| Invoice | 1 | PO Number | 123 |
| Invoice | 3 | Invoice Number | xyz |
| Shipment Status | 2 | Shipment ID | abc |
| Freight Invoice | 2 | Shipment ID | abc |
| Freight Invoice | 4 | Invoice Number | 999 |
| Remittance Advice | 3 | Invoice Number | xyz |

One embodiment of the invention provides a Log Detail database. The Log Detail database will be updated with the following entries as each transaction is processed through the Life Cycle Analyzer (as shown below in Table 2).

TABLE 2

| | | | | Life | Document |
|---|---|---|---|---|---|
| | | | | Cycle | Archive |
| Sender | Receiver | Time Stamp | Transaction | ID | Index |
| Buyer | Mfg | Sep. 01, 2002 10:00 AM | PO | 1 | 1 |
| Mfg | Buyer | Sep. 01, 2002 10:30 AM | PO Ack. | 1 | 2 |
| Mfg | Logistic | Sep. 05, 2002 08:00 AM | Load Tender | 1 | 3 |
| Mfg | Logistic | Sep. 05, 2002 08:00 AM | Load Tender | 2 | 3 |
| Logistic | Mfg | Sep. 05, 2002 08:15 AM | Respond to Load | 2 | 4 |
| | | | Tender | | |
| Mfg | Buyer | Sep. 07, 2002 13:00 PM | Advance | 1 | 5 |
| | | | Shipment Notice | | |
| Mfg | Buyer | Sep. 07, 2002 13:00 PM | Advance | 2 | 5 |
| | | | Shipment Notice | | |
| Mfg | Buyer | Sep. 07, 2002 14:00 PM | Invoice | 1 | 6 |
| Mfg | Buyer | Sep. 07, 2002 14:00 PM | Invoice | 3 | 6 |
| Logistic | Mfg | Sep. 08, 2002 13:00 PM | Shipment Status | 2 | 7 |
| Logistic | Mfg | Sep. 09, 2002 13:00 PM | Shipment Status | 2 | 8 |
| Logistic | Mfg | Sep. 10, 2002 15:00 PM | Freight Invoice | 2 | 9 |
| Logistic | Mfg | Sep. 10, 2002 15:00 PM | Freight Invoice | 4 | 9 |
| Buyer | Mfg | Sep. 10, 2002 10:00 AM | Remittance | 3 | 10 |
| | | | Advice | | |

One embodiment of the present invention provides an Archive Database. The Archive Database will be updated with the following entries as each transaction is processed through the Life Cycle Analyzer (as shown below in Table 3).

TABLE 3

| Document | |
|---|---|
| Archive | |
| Index | Document location |
| 1 | /dt/user/data/archive/PO.txt |
| 2 | /dt/user/data/archive/POA.txt |
| 3 | /dt/user/data/archive/LOADTENDER.txt |
| 4 | /dt/user/data/archive/RESPOND.txt |
| 5 | /dt/user/data/archive/ASN.txt |
| 6 | /dt/user/data/archive/INVOICE.txt |
| 7 | /dt/user/data/archive/SHIPSTAT.txt |
| 8 | /dt/user/data/archive/SHIPSTAT2.txt |
| 9 | /dt/user/data/archive/FRTINV.txt |
| 10 | /dt/user/data/archive/RMTADV.txt |

As one example illustrated in one embodiment of the present invention, during this process, when a buyer logs onto the manufacturer's Life Cycle Analyzer on 9/6/02 entering the PO number, the following events will occur:
1. The Life Cycle Analyzer locates the Life Cycle ID of 1 for this PO. This ID is then used to look up the Log Detail database which locates thein PO, PO Ack, Load Tender transactions.
2. From the Load Tender transaction, the system identifies a 2^{nd} Life Cycle ID of 2. This ID is then used again to look up from the Log Detail database, which results in the return on an additional transaction, Respond to Load Tender.
3. Using the time stamp on the Log Detail table, the Life Cycle Analyzer displays these transactions in chronological order, via a browser. This information shows the buyer that the shipment arrangement has been made and the actual ship date is set for the order. If the buyer logs into the system at a later date, more information will be available and this will continue to provide the buyer with up-to-date information about the order.

Another example of the Life Cycle Analyzer application (in one embodiment of the invention) is the reconciliation process. For example, the accounts receivable (AR) department of a manufacturer needs the support documents to rectify the accuracy of a payment from the buyer. The AR user enters the invoice number into Life Cycle Analyzer, which triggers the following events:
1. The Life Cycle Analyzer locates the Life Cycle ID of 3 for this invoice. This ID is then used to look up the Log Detail database which returns the Invoice and Remittance Advice transactions.
2. From the Invoice transaction, the system identifies a 2^{nd} Life Cycle ID of 1. This ID is then used again to look up the Log Detail database, which returns additional transactions—PO, PO Ack, Load Tender, and Advance Shipment Notice.
3. Using the time stamp on the Log Detail table, the Life Cycle Analyzer displays these transactions in chronological order, via a browser. In addition, each transaction listed also has a Document Archive Index that pinpoints the exact location where the content of the document is stored.
4. Using this information, the AR user is able to compare the original purchase order with the actual goods shipped, the actual invoice sent, and finally the payment information from the bank. This represents a tremendous time saving for the AR users in their account reconciliation process.

A third example of the Life Cycle Analyzer application (according to one embodiment of the invention) is the Accounts Payable (AP) verification process. A manufacturer's AP department needs to verify that the service has been delivered before paying the freight invoice. The AP user enters the freight invoice number into Life Cycle Analyzer, which triggers the following actions:
1. The Life Cycle Analyzer locates the Life Cycle ID of 4 for this freight invoice. This ID is then used to look up Log Detail database that returns the Freight Invoice transaction.
2. From the Freight Invoice transaction, the system identifies a 2^{nd} Life Cycle ID of 2. This ID is then used again to look up the Log Detail database, which returns additional transactions—Load Tender, Respond to Load Tender, Advance Shipment Notice, and Shipment Status.
3. Using the time stamp on the Log Detail table, Life Cycle Analyzer displays these transactions in chronological order, via a browser. In addition, each transaction listed also has a Document Archive Index that pinpoints the exact location where the content of the document is stored.
4. Using this information, the AP user is able to easily compare the freight invoice against the original order (Load Tender), and the services rendered (Shipment Status) before making the payment.

According to one example embodiment of the invention, the transaction processor provides for parsing an electronic transaction and in turn capturing the transaction and storing it in the life cycle data structure for later retrieval. As further illustrated, the system is completely transparent to the other systems used by an entity for e-commerce, such as their ERP or EDI systems.

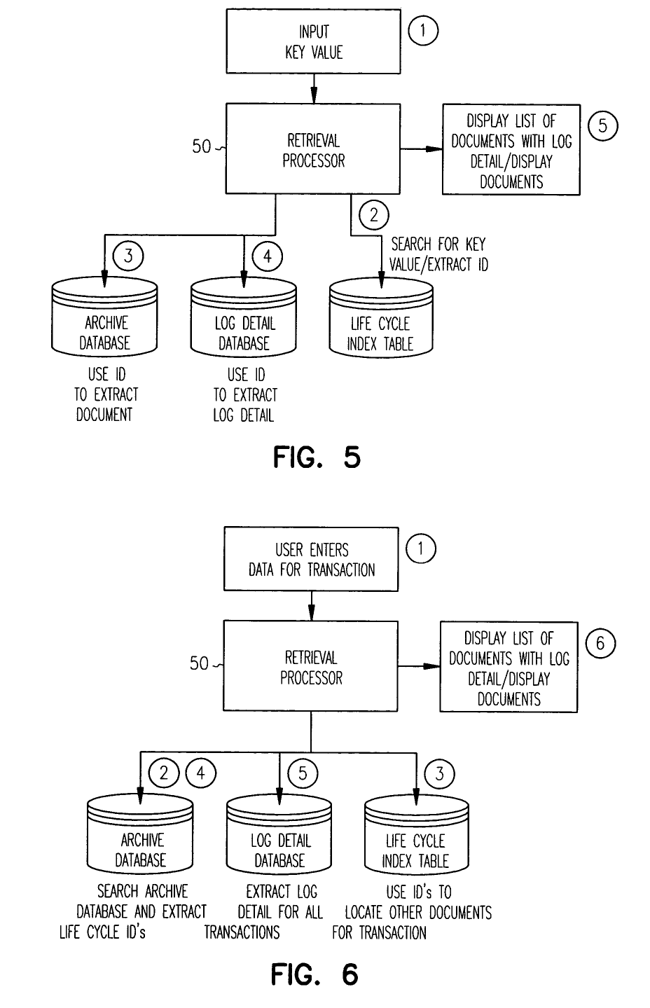

According to still another example embodiment of the invention, there are provided at least two retrieval mechanisms: key value retrieval and secondary retrieval. As illustrated in FIG. 5, this retrieval is performed by a retrieval processor 50 that is, in one example embodiment, a computer program stored on a medium such as magnetic media, optical media or a stream of instructions conveyed over a network.

FIG. 5 illustrates an example embodiment of the key value retrieval mechanism performed by retrieval processor 50. A user can enter (1) any one of the key values of a business or other type of transaction, such as PO number or invoice number. This key value is used to search the life cycle Index table (2). When a match is found, the life cycle ID is extracted from the index table and used to retrieve all related documents in the archive database (3). This life cycle ID is also used to link the log detail table to the archive database in order (4) to provide the chronological order when displaying these retrieved life cycle documents.

Retrieval processor 50 accordingly accesses all documents or items associated with an entered key value, and obtains log detail information concerning the same in order to present to the user a comprehensive set of items and their associated dates and times for the transaction in question (5).

FIG. 6 illustrates an example embodiment of the secondary retrieval mechanism performed by retrieval processor 50 according to one example embodiment of the invention. In addition to key values, the users may also use any piece of information related to the business transaction in question (1), such as a product universal product code (UPC). The system will search the archive database to locate documents containing this information (2). Once the documents are located, its life cycle IDs are used to retrieve all additional documents related to this business transaction (3)(4). Again, the log detail tables provide the chronological order (5) for displaying (6) these documents.

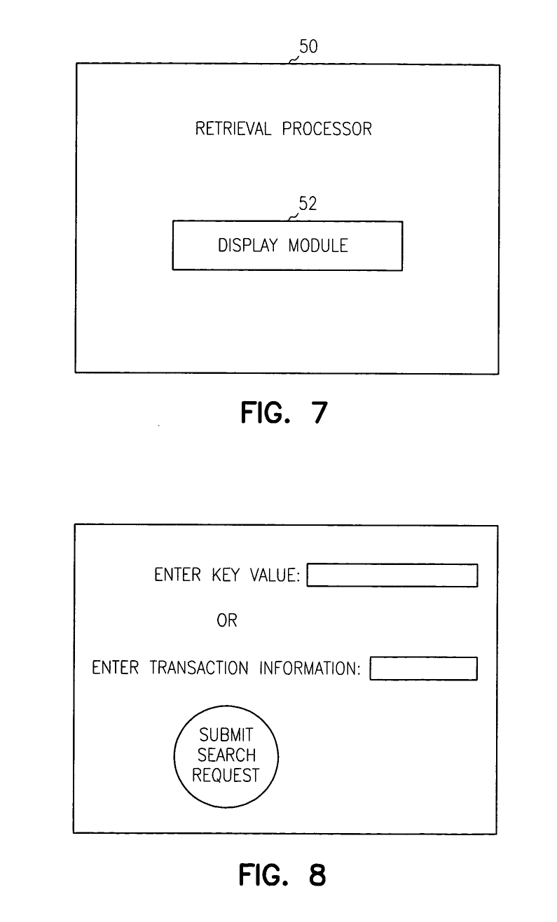

According to one example embodiment as shown in FIG. 7, retrieval processor 50 includes a display module 52 that is adapted for generating a display of search results in a hypertext markup language or XML or other web and browser compatible display coding. Further, according to another example embodiment, a search criteria input screen is also web and browser enabled, for example shown in FIG. 8, allowing a user to use a web browser interface for inputting search requests and for viewing search results. Further according to this embodiment, retrieval processor 50 can process a user's “click” on a hyperlink in the document display and in turn retrieve an archived document and display it in a web compatible format such as HTML or XML, or serve up a document in other formats such as PDF, TIFF, Word, Excel, or any other document format that can be downloaded to a user's terminal and opened for viewing either inside or outside of the user's browser. Of course, the invention is in no way limited to a browser implementation and the user interface is, in other example embodiments, implemented in other applications executable on, for instance, computing platforms in use such as Windows/PC, Macintosh, Sun Solaris platforms, UNIX, AS400 systems and others.

Accordingly, the retrieval processor of the present invention is, in one example embodiment, web enabled, and allows users to use familiar web interface pages to enter search requests and to display search results. Benefits include an easy to learn interface and accessibility from any web browser enabled computing platform.

Although described above with respect to the example of electronic commerce, the invention has applications in any business that engages other parties to complete its business cycles using electronic systems. Some examples are: Health Care Industry, Insurance Industry, Import/Export industry, Law firms, and Government Agencies.

For example, according to yet another example embodiment, the electronic transactions related to medical records and/or payment systems, wherein medical billing and procedure records are the documents or items processed between various entities in billing, payment and insurance reimbursement.

Thus, there has been described above various embodiments of the invention in the form of systems, software and methods for capturing, storing and retrieving data items associated with electronic transactions. Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the described embodiments of the present invention.

1. A method comprising:
two or more different systems producing electronic data relating to a transaction involving documentation communicated in an electronic form;
processing copies of the electronic data to identify electronic documentation items and at least one key value associated with an electronic documentation item;
using the key value to look up a transaction identifier associated with the transaction;
indexing the documentation items according to key value and transaction identifier;
archiving the documentation items in a data storage system or device; and
logging a date and/or time associated with at least some of the documentation items.

2. A data structure stored in storage medium, comprising:
a transaction specification database that contains specifications and schema for one or more transaction types and key values of each transaction type;
a life cycle Index table that contains the key values of the processed transactions and the assigned life cycle IDs for the key values;
an archive database that contains the archived documents or items and their life cycle IDs; and
a log detail database that provides chronological order to transactions by logging and time stamping each transaction parsed.

3. A system comprising:
a first interface used to couple the system with a first external system producing first electronic data relating to a transaction involving documentation communicated in an electronic form;
a second interface used to couple the system with a second external system producing second electronic data relating to the transaction; and
wherein the system is operable to:
process copies of the first and second electronic data to identify electronic documentation items and at least one key value associated with an electronic documentation item;
use the key value to look up a transaction identifier associated with the transaction;
index the documentation items according to key value and transaction identifier;
archive the documentation items; and
log a date and/or time associated with at least some of the documentation items.
